(19) United States
(12) Patent Application Publication
(10) Pub. No.: US 2024/0020178 A1
(43) Pub. Date: Jan. 18, 2024

(54) TECHNIQUES FOR CONTROLLING SIMULATION FOR HARDWARE OFFLOADING SYSTEMS

(71) Applicants: Lemon Inc., Grand Cayman (KY); Beijing Volcano Engine Technology Co., Ltd., Beijing (CN)

(72) Inventors: Shan XIAO, Beijing (CN); Hui ZHANG, Los Angeles, CA (US); Bo LI, Beijing (CN); Chul LEE, Los Angeles, CA (US); Ping ZHOU, Los Angeles, CA (US); Fei LIU, Los Angeles, CA (US)

(21) Appl. No.: 18/476,004

(22) Filed: Sep. 27, 2023

(51) Int. Cl. G06F 9/50

(52) U.S. Cl. CPC G06F 9/5083

(57) ABSTRACT

Described are examples for simulating performance of a hardware offloading system including receiving, by a simulator that corresponds to a simulated architecture representing the hardware offloading system, input data from a user application for processing by the simulated architecture, preparing, by the simulator, corresponding output data for the input data without computing the corresponding output data by the simulated architecture, and returning, by the simulator, the corresponding output data to the user application after a simulated idle time related to computing the corresponding output data by the simulated architecture.

### BACKGROUND The described aspects relate to simulator applications, and more particularly, simulators for

hardware offloading systems.

In bigdata analytics, most of the computations performed are simple and repetitive over large data sets. As such, the computations can be optimized with hardware-based accelerators, such as a field programmable gate array (FPGA), graphics processing unit (GPU), etc. Designing and optimizing hardware offloading systems, however, can be a challenging and time consuming process, which can result in high cost for projects that co-design hardware and software for analytics. Having a solid proof-of-concept (PoC) can be beneficial in this regard. In designing the hardware for an analytics engine, a system simulator can be developed to obtain a PoC estimate for hardware design proposals. Typically, a simulator for a hardware offloading systems is executed on a processor such as a central processing unit (CPU) that can execute applications such as the simulator. For example, the simulator can use multiple CPU threads as offloading engines to perform calculations that the hardware-based accelerators in the designed and simulated hardware.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In an example, a computer-implemented method for simulating performance of a hardware offloading system is provided that includes receiving, by a simulator that corresponds to a simulated architecture representing the hardware offloading system, input data from a user application for processing by the simulated architecture, preparing, by the simulator, corresponding output data for the input data without computing the corresponding output data by the simulated architecture, and returning, by the simulator, the corresponding output data to the user application after a simulated idle time related to computing the corresponding output data by the simulated architecture.

In another example, an apparatus for simulating performance of a hardware offloading system, including one or more processors and one or more non-transitory memories with instructions thereon. The instructions upon execution by the one or more processors, cause the one or more processors to receive, by a simulator that corresponds to a simulated architecture representing the hardware offloading system, input data from a user application for processing by the simulated architecture, prepare, by the simulator, corresponding output data for the input data without computing the corresponding output data by the simulated architecture, and return, by the simulator, the corresponding output data to the user application after a simulated idle time related to computing the corresponding output data by the simulated architecture.

In another example, one or more non-transitory computer-readable storage media are provided that store instructions that when executed by one or more processors cause the one or more processors to execute a method for simulating performance of a hardware offloading system. The method includes receiving, by a simulator that corresponds to a simulated architecture representing the hardware offloading system, input data from a user application for processing by the simulated architecture, preparing, by the simulator, corresponding output data for the input data without computing the corresponding output data by the simulated architecture, and returning, by the simulator, the corresponding output data to the user application after a simulated idle time related to computing the corresponding output data by the simulated architecture.

To the accomplishment of the foregoing and related ends, the one or more implementations comprise the features hereinafter fully described and particularly pointed out in the claims. The following description and the annexed drawings set forth in detail certain illustrative features of the one or more implementations. These features are indicative, however, of but a few of the various ways in which the principles of various implementations may be employed, and this description is intended to include all such implementations and their equivalents.

### BRIEF DESCRIPTION OF THE DRAWINGS

FIG. 1 is a schematic diagram of an example of a system for performing simulation of a hardware offloading system, in accordance with examples described herein.

FIG. 2 is a flowchart of an example of a method for executing a simulator for a hardware offloading system, in accordance with examples described herein.

FIG. 3 is a schematic diagram of an example of a system for executing a simulator for a hardware offloading system, in accordance with examples described herein.

FIG. 4 is a schematic diagram of an example of a device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to controlling a simulation or simulator (e.g., a simulation application) for a hardware offloading system. As described, the hardware offloading system can be designed to process big data or otherwise facilitate big data analytics using one or more hardware-based accelerators, such as a field programmable gate array (FPGA), graphics processing unit (GPU), data processing unit (DPU), smart network cards (SmartNIC), etc. to perform repetitive computations over large data sets. For example, a DPU can include a system-on-a-chip (SoC) that combines a multi-core processor, a high-performance network, and/or a set of acceleration engines that offload application performance for various functions. The hardware offloading system can be designed, tested, or otherwise simulated using a simulator to simulate the architecture selected for the hardware offloading system. Typically, the simulator executes as an application on an central processing unit (CPU)-based system. As such, the simulator typically uses a CPU core to simulate a hardware intellectual property (IP) core for data processing, where the IP core can be a higher performance processor, such as a FPGA, GPU, DPU, SmartNIC, etc. provided by a hardware vendor.

The higher performance processors, such as FPGAs, provide certain features not found in CPUs to achieve the higher performance, such as massive parallel execution, deep-pipeline lining, on- the-fly computation, vectorization, high-speed memory (e.g., static random access memory (SRAM)) usage, etc., for actual computation on data or tables, including filtering, aggregation, and projection, etc. In this regard, the higher performance processors outperform (e.g., can have a higher performance parameter or metric than) CPUs, and when using the simulator to estimate benefits or performance of the hardware offloading system, it can be difficult for the CPU to achieve the data processing speed of the actual hardware IP core. As a result, the gap between estimated results and the real results may be inconsistent.

Aspects described herein relate to controlling the simulator to obtain, for input data, corresponding output data without the CPU having to perform calculation to compute the corresponding output data. For example, the simulator can store, for the input data, the corresponding output data in memory, where the corresponding output data can be computed in a first (or previous) run of the simulator. During a subsequent simulation, the simulator can then retrieve, for the input data, the corresponding output data without having to compute the output data, which can significantly enhance performance of the simulation. In addition, for more accurate performance results, the simulator can wait for a simulated idle time before returning the retrieved output data, where the simulated idle time can correspond to a time for the hardware offloading system (or corresponding high performance processor) to perform the associated computation. In this regard, the performance of the simulated hardware offloading system can be measured without being subject to inefficiencies of the CPU on which the simulator is executing. This can allow for providing or obtaining more accurate performance results of the simulated architecture for the hardware offloading system.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

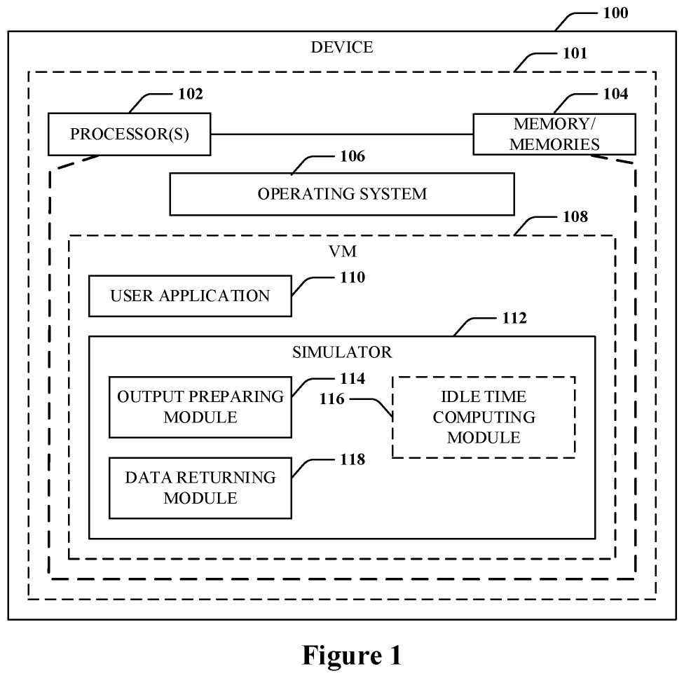

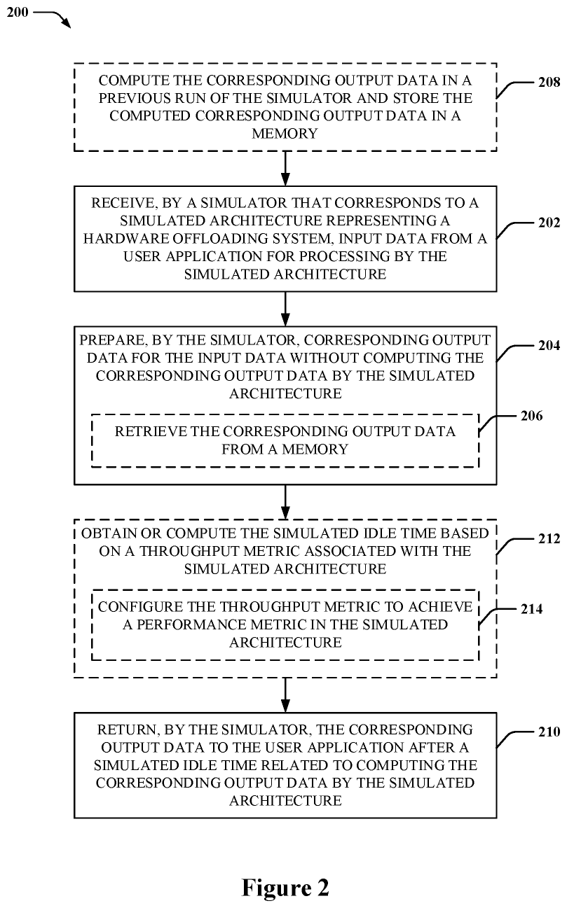

Turning now to FIGS. 1-4, examples are depicted with reference to one or more components and one or more methods that may perform the actions or operations described herein, where components and/or actions/operations in dashed line may be optional. Although the operations described below in FIG. 2 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a system for performing simulation of a hardware offloading system, in accordance with aspects described herein. The system includes a device 100 (e.g., a computing device) that includes processors(s) 102 (e.g., one or more processors) and/or memory/memories 104 (e.g., one or more memories). In an example, device 100 can include processor(s) 102 and/or memory/memories 104 configured to execute or store instructions or other parameters related to providing an operating system 106, which can execute one or more applications, services, etc. In another example, the device 100 can execute a virtual machine (VM) 108, which can execute the user application 110 and/or a simulator 112. For example, the user application 110 may include a user application that provides input to the simulator 112 and receives output from the simulator 112, such as input/output for big data analytics, such that the simulator 112 can simulate computations performed by the simulated architecture of the hardware offloading system.

For example, processor(s) 102 and memory/memories 104 may be separate components communicatively coupled by a bus (e.g., on a motherboard or other portion of a computing device, on an integrated circuit, such as a system on a chip (SoC), etc.), components integrated within one another (e.g., processor(s) 102 can include the memory/memories 104 as an on-board component 101), and/or the like. In other examples, processor(s) 102 can include multiple processors 102 of multiple devices 100, memory/memories 104 can include multiple memories 104 of multiple devices 100, etc. Memory/memories 104 may store instructions, parameters, data structures, etc., for use/execution by processor(s) 102 to perform functions described herein.

In addition, the device 100 can include substantially any device that can have a processor(s) 102 and memory/memories 104, such as a computer (e.g., workstation, server, personal computer, etc.), a personal device (e.g., cellular phone, such as a smart phone, tablet, etc.), a smart device, such as a smart television, and/or the like. Moreover, in an example, various components or modules of the device 100 may be within a single device, as shown.

In an example, the simulator 112 can optionally include an output preparing module 114 for preparing output for returning to a user application as part of a simulation, an idle time computing module 116 for computing an idle time to wait before returning the prepared output data, and/or a data returning module 118 for returning the data (e.g., after the computed idle time). The simulator 112 can simulate an architecture of a desired hardware offloading system such that the user application 110 can provide input data to the simulator and/or receive corresponding output data from the simulator, as would be provided to and/or received from the hardware offloading system. In an example, the simulator 112, the user application 110, or another application can measure the performance of the simulator 112 to determine an expected or estimated performance of an actual hardware offloading system that uses the actual architecture being simulated by simulator 112. As described, for example, the hardware offloading system can include one or more higher performance processors, such as FPGA(s), GPU(s), DPU(s), SmartNlC(s), etc., and the performance of the architecture of the designed hardware offloading system can be simulated by simulator 112.

For example, user application 110 can execute to provide input data to the simulator 112, which can occur in a VM 108 or otherwise. For example, device 100 can execute a machine emulator, which can initialize the VM 108 on the device 100. The emulator can execute the simulator 112 (e.g., in the VM 108) and the user application 110 can also execute in the VM 108. In accordance with aspects described herein, simulator 112 can receive the input data, output preparing module 114 can prepare corresponding output data for the input data, and data returning module 118 can return the corresponding output data to the user application 110. As the performance of the architecture of the hardware offloading system being simulated can exceed the capabilities of the processor executing the simulator 112 (e.g., processor 102), simulator 112 can refrain from computing the corresponding output data, and can return the output data as retrieved from memory/memories 104, which can allow the simulator 112 to perform at speeds more comparable to the architecture of the hardware offloading system being simulated. For example, simulator 112 can compute and store (e.g., in memory/memories 104) the corresponding output data for the input data received from user application 110 in an initial (or previous) run of the simulation. In any case, output preparing module 114 can obtain the corresponding output data for the input data from memory/memories 104 for returning to the user application 110.

In one example, the speed of memory retrieval can be faster than the computation that would be performed by the architecture of the hardware offloading system being simulated, and as such, idle time computing module 116 can compute an idle time for the simulator 112 to wait before data returning module 118 returns the corresponding output data. In an example, idle time computing module 116 can compute the idle time based on a throughput metric that represents the performance of the architecture of the hardware offloading system being simulated (e.g., the time it would take the architecture to perform computation on the received input data to compute the corresponding output data). The throughput metric may be configurable, which can allow for simulation of different hardware offloading systems. In any case, by refraining from computing the corresponding output data, the simulator 112 can achieve performance that is more closely aligned with the architecture of the hardware offloading system being simulated, though the processor(s) 102 are more performance limited than the higher performance processors in the architecture of the hardware offloading system being simulated.

FIG. 2 is a flowchart of an example of a method 200 for executing a simulator for a hardware offloading system, in accordance with aspects described herein. For example, method 200 can be performed by a device 100 executing simulator 112 and/or one or more components thereof for simulating the hardware offloading system.

In method 200, at action 202, input data from a user application can be received, by a simulator that corresponds to a simulated architecture representing a hardware offloading system, for processing by the simulated architecture. For example, the simulator 112 can be a simulator that corresponds to a simulated architecture representing a hardware offloading system. For example, the hardware offloading system can include one or more higher performance processors, such as FPGA(s), GPU(s), DPU(s), SmartNIC(s), etc., and the simulator 112 can simulate performance and operation thereof. In an example, simulator 112, e.g., in conjunction with processor(s) 102, memory/memories 104, operating system 106, an emulator (e.g., Qemu) etc., can receive input data from the user application for processing by the simulated architecture. For example, user application 110 can interface with the simulator 112 to provide the input data thereto, and simulator 112 can provide corresponding output data for the input data. Simulators typically compute the corresponding output data for the input data; aspects described herein, however, relate to preparing the output data in other ways to prevent having to compute the output data via the simulator 112, which may execute more slowly than the simulated architecture due to limitations of the processor(s) 102. In one example, simulator 112 can receive the input data from the user application 110 using direct memory access (DMA) with the user application 110 (e.g., based on DMA information received from the user application 110). In one example, as described, the input data can correspond to big data analytics or other data sets for which repetitive computation is desired.

In method 200, at action 204, corresponding output data for the input data can be prepared by the simulator without computing the corresponding output data by the simulated architecture. In an example, output preparing module 114, e.g., in conjunction with processor(s) 102, memory/memories 104, operating system 106, simulator 112, etc., can prepare the corresponding output data for the input data without computing the corresponding output data by the simulated architecture. In one example, in preparing the corresponding output data at action 204, optionally at action 206, the corresponding output data can be retrieved from a memory. In an example, output preparing module 114 can retrieve the corresponding output data from memory/memories 104 without having to compute the corresponding output data, which can allow for mitigating inefficiencies of using processor 102 to compute the output data and more closely align performance of the simulated architecture with the actual architecture of the hardware offloading system being simulated.

In method 200, optionally at action 208, the corresponding output data can be computed in a previous run of the simulator and stored in a memory. In an example, simulator 112, e.g., in conjunction with processor(s) 102, memory/memories 104, operating system 106, etc., can execute an initial or previous run of the simulator 112 (e.g., based on input data from user application 110 or otherwise) and can store the computed corresponding output data in the memory/memories 104. For example, in the initial run, the simulator 112 can receive the input data, compute the output data, and output preparing module 114 can store the output data in memory/memories 104. In an example, output preparing module 114 can store the output data with a mapping to the input data to facilitate retrieving the output data from the memory/memories 104 in subsequent runs of the simulator 112 based on data from the user application 110. In one example, output preparing module 114 can store the output data with an identifier generated based on the input data to facilitate fast retrieval of the output data in the next run.

For example, if the input data being offloaded for simulation includes a decompression operator, the output can be decompressed data. As the input data from the user application 110 does not change, the decompressed data also does not change. As such, during the initial run, simulator 112 can cache the output data emulated on the simulator 112 into memory/memories 104 using a map structure similar to the following:
<compressed data identify key 1, decompressed data>
<compressed data identify key 2, decompressed data>
. . .
<compressed data identify key n, decompressed data>

In this example, in retrieving the corresponding data in a subsequent run, output preparing module 114 can obtain the output data corresponding to each input data based on mapping the input data identifier to the decompressed output data, where the retrieval can execute faster than a full compute operation.

In method 200, at action 210, the corresponding output data can be returned by the simulator to the user application after a simulated idle time related to computing the corresponding output data by the simulated architecture. In an example, data returning module 118, e.g., in conjunction with processor(s) 102, memory/memories 104, operating system 106, simulator 112, etc., can return the corresponding output data to the user application after the simulated idle time related to computing the corresponding output data by the simulated architecture. For example, data returning module 118 can return the output data retrieved from memory/memories 104 without computation during this run of the simulator 112. The idle time can correspond to a time it would take for the simulated architecture to compute the output data to provide a performance of simulator 112 that is more closely aligned with the actual performance of the actual architecture being simulated. In addition, in one example, data returning module 118 can return the output data to the user application 110 using DMA (e.g., based on DMA information received from the user application 110). In one example, output preparing module 114 may prepare the data for output after the simulated idle time, and data returning module 118 can return the prepared data. In either case, simulator 112 can wait for the simulated idle time before returning the prepared data.

In method 200, optionally at action 212, the simulated idle time can be obtained or computed based on a throughput metric associated with the simulated architecture. In an example, idle time computing module 116, e.g., in conjunction with processor(s) 102, memory/memories 104, operating system 106, simulator 112, etc., can obtain or compute the simulated idle time based on a throughput metric associated with the simulated architecture. For example, the simulated architecture may be associated with a throughput metric that is achievable using the corresponding processors (e.g., FPGA(s), GPU(s), DPU(s), SmartNIC(s), etc.). This throughput metric can be used to generate the idle time the data returning module 118 can wait before returning corresponding output data to the user application to better represent the performance of the architecture of the hardware offloading system being simulated. For example, idle time computing module 116 can compute the idle time, t, based on a formula similar to the following:

$$t = \frac{{Size}_{inputdata}}{tps}$$

where Size_{inputdata} is the size of the input data received from the user application, and tps can be the throughput associated with the architecture of the hardware offloading system (e.g., the throughput of the higher performance processors or associated hardware IP cores, etc.). The size of the input data can be determined during the first run of the simulator 112 on the set of input data from user application 110. In addition, the throughput metric can be configurable to allow for simulating other architectures having different throughput metrics.

Thus, in obtaining or computing the simulated idle time at action 212, for example, optionally at action 214, the throughput metric can be configured to achieve a performance metric in the simulated architecture. In an example, idle time computing module 116, e.g., in conjunction with processor(s) 102, memory/memories 104, operating system 106, simulator 112, etc., can configure the throughput metric to achieve a performance metric in the simulated architecture. In one example, idle time computing module 116 can provide or communicate with an interface that allows for specifying the throughput metric of the architecture of the hardware to be simulated. As such, idle time computing module 116 can compute and provide the idle time based on hardware offloading system performance to allow for more accurate or precise simulation of the actual architecture of the hardware offloading system.

In some examples, the performance of the simulated architecture can be tracked or measured by the simulator 112, by the user application 110, or by a different application. For example, the performance of simulating computing of the output data, or other metrics such as speed of the operations, speed of completing the data processing, processor speed, memory capacity or performance, number of memory accesses, time of memory accesses, etc., can be monitored as the simulator 112 executes.

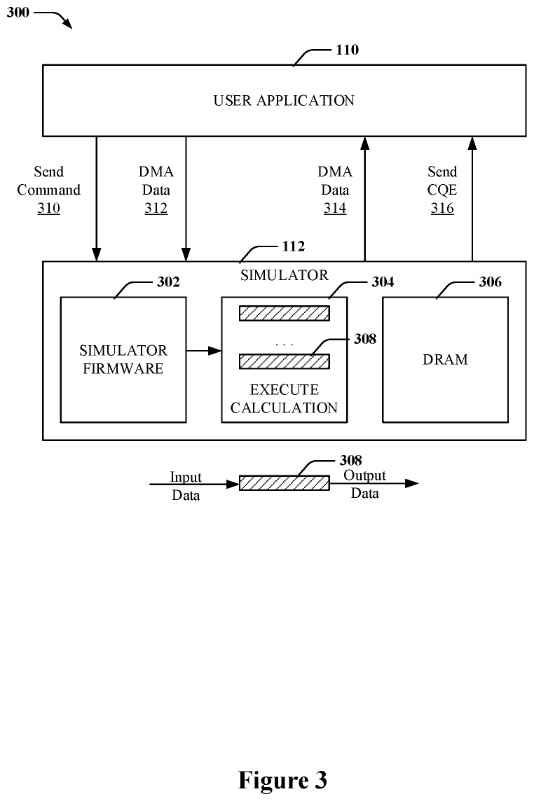

FIG. 3 is a schematic diagram of an example of a system 300 for executing a simulator for a hardware offloading system, in accordance with aspects described herein. For example, system 300 can include a user application 110 and a simulator 112, as described. Simulator 112 can include simulator firmware 302 for executing a simulation of an architecture of a hardware offloading system, an execute calculation step 304, and a dynamic random access memory (DRAM) 306 for storing output data during one run of a simulation for use in a next run of the simulation. For example, simulator firmware 302 may execute on one or more processors, such as processor(s) 102 that may include a CPU. In addition, for example, DRAM 306 can be similar to or can include at least a portion of memory/memories 104. In accordance with aspects described herein, at the execute calculation step 304, instead of computing output data, a memory retrieval operation 308 can be performed to obtain output data from DRAM 306 that corresponds to the input data. As described, for example, the simulator 112 can execute a previous run of the simulation where the output data is computed, and can store the computed output data in DRAM 306 for use in subsequent runs of the simulation to provide performance that is more precise for the architecture of the hardware offloading system being simulated.

In system 300, user application 110 can send a command 310 to the simulator 112 to being simulation. User application 110 can then DMA data 312 to the simulator 112. Simulator firmware 302 can simulate the architecture of the hardware offloading system to receive the input data using DMA, process the data (e.g., by execute calculation step 304), and provide the resulting output data to the user application 110 via DMA (e.g., DMA data 314). The simulator 112 can then send a completion entry (CQE) 316 to the user application 110 to indicate the output data has been returned. In an example, during execute calculation step 304, the output data, previously stored in DRAM 306, is retrieved from DRAM 306 instead of computing the output data. In addition, during the execute calculation step 304, simulator 112 can wait the idle time before returning the output data to the user application 110 via DMA data 314.

A goal of the simulator 112 can be to obtain correct output data, and how the hardware offloading system achieves computing the correct output data may not be of concern. As such, the process of the offloading operations performed in the execute calculation step 304 can considered as black box. In this regard, a memory retrieval operation can be used to obtain the output data, which can be more speed performant than a compute operation, which can offset performance differences between the processor(s) 102 executing the simulator 112 and the higher performance processors of the hardware offloading system being simulated. In addition, the server executing simulator 112 (e.g., device 100) can have memory capacity sufficient for storing the result of the calculations of the simulated architecture (e.g., as obtained in an initial or previous run of the simulator 112 on the input data from the user application 110).

For example, the simulator 112 can be leveraged for a specific workload of input data from the user application 110. In this example, the output data computed for the input data during a first run of the simulation can be cached in DRAM 306. In later runs, this output data cached in DRAM 306 can be retrieved and output to the user application 110 based on the configurable IP core performance (e.g., based on the configured throughput metric and associated computed idle time, as described). Thus, for example, the simulated architecture can idle for a specific period of time, then can return the output data selected from the cached data for a set of input data to the user application 110. In this regard, the throughput of the simulated IP core can become a configurable parameter, as described. In addition, for example, the throughput metric can be tuned to execute the simulator 112 with a different simulated architecture (e.g., the throughput metric or associated idle time can be halved to simulate twice the offloading IP core performance). Thus, using this simulator 112, the execution of a hardware offloading system or IP can be with controlled required performance and/or an end-to-end system performance can be tested with an increase (or decrease) in the number of hardware offloading IPs.

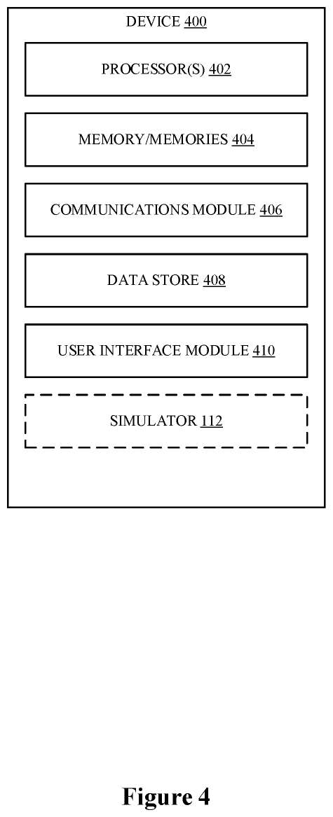

FIG. 4 illustrates an example of device 400, similar to or the same as device 100 (FIG. 1), including additional optional component details as those shown in FIG. 1. In one implementation, device 400 may include processor(s) 402, which may be similar to processor(s) 102 for carrying out processing functions associated with one or more of components and functions described herein. Processor(s) 402 can include a single or multiple set of processors or multi-core processors. Moreover, processor(s) 402 can be implemented as an integrated processing system and/or a distributed processing system.

Device 400 may further include memory/memories 404, which may be similar to memory/memories 104 such as for storing local versions of applications being executed by processor(s) 402, such as simulator 112, related modules, instructions, parameters, etc. Memory/memories 404 can include a type of memory usable by a computer, such as random access memory (RAM), read only memory (ROM), tapes, magnetic discs, optical discs, volatile memory, non-volatile memory, and any combination thereof.

Further, device 400 may include a communications module 406 that provides for establishing and maintaining communications with one or more other devices, parties, entities, etc., utilizing hardware, software, and services as described herein. Communications module 406 may carry communications between modules on device 400, as well as between device 400 and external devices, such as devices located across a communications network and/or devices serially or locally connected to device 400. For example, communications module 406 may include one or more buses, and may further include transmit chain modules and receive chain modules associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with implementations described herein. For example, data store 408 may be or may include a data repository for applications and/or related parameters (e.g., simulator 112, related modules, instructions, parameters, etc.) being executed by, or not currently being executed by, processor(s) 402. In addition, data store 408 may be a data repository for simulator 112, related modules, instructions, parameters, etc., and/or one or more other modules of the device 400.

Device 400 may include a user interface module 410 operable to receive inputs from a user of device 400 and further operable to generate outputs for presentation to the user. User interface module 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface module 410 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more implementations, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various implementations described herein. Various modifications to these implementations will be readily apparent to those skilled in the art, and the generic principles defined herein may be applied to other implementations. Thus, the claims are not intended to be limited to the implementations shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various implementations described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for simulating performance of a hardware offloading system, comprising:
receiving, by a simulator that corresponds to a simulated architecture representing the hardware offloading system, input data from a user application for processing by the simulated architecture;
preparing, by the simulator, corresponding output data for the input data without computing the corresponding output data by the simulated architecture; and
returning, by the simulator, the corresponding output data to the user application after a simulated idle time related to computing the corresponding output data by the simulated architecture.

2. The computer-implemented method of claim 1, wherein preparing the corresponding output data includes retrieving the corresponding output data from a memory, wherein the corresponding output data is computed during a previous run of the simulator and stored in the memory.

3. The computer-implemented method of claim 2, wherein the corresponding output data is mapped, in the memory, to the input data during the previous run of the simulator, and wherein preparing the corresponding output data includes retrieving the corresponding output data that is mapped to the input data.

4. The computer-implemented method of claim 1, further comprising computing the simulated idle time based on a throughput metric associated with the simulated architecture.

5. The computer-implemented method of claim 4, wherein the simulated idle time is a function of the throughput metric and a size of the input data.

6. The computer-implemented method of claim 4, further comprising configuring the throughput metric to achieve a performance metric in the simulated architecture.

7. The computer-implemented method of claim 1, wherein the simulator is executed by a first processor, and wherein the simulated architecture is associated with one or more second processors having a higher performance parameter than the first processor.

8. The computer-implemented method of claim 1, further comprising receiving a direct memory access (DMA) information from the user application, wherein returning the corresponding output data to the user application is by DMA to the user application.

9. An apparatus for simulating performance of a hardware offloading system, the apparatus comprising one or more processors and one or more non-transitory memories with instructions thereon, wherein the instructions upon execution by the one or more processors, cause the one or more processors to:
receive, by a simulator that corresponds to a simulated architecture representing the hardware offloading system, input data from a user application for processing by the simulated architecture;
prepare, by the simulator, corresponding output data for the input data without computing the corresponding output data by the simulated architecture; and
return, by the simulator, the corresponding output data to the user application after a simulated idle time related to computing the corresponding output data by the simulated architecture.

10. The apparatus of claim 9, wherein the instructions upon execution by the one or more processors, cause the one or more processors to prepare the corresponding output data at least in part by retrieving the corresponding output data from a memory, wherein the corresponding output data is computed during a previous run of the simulator and stored in the memory.

11. The apparatus of claim 10, wherein the corresponding output data is mapped, in the memory, to the input data during the previous run of the simulator, and wherein the instructions upon execution by the one or more processors, cause the one or more processors to prepare the corresponding output data at least in part by retrieving the corresponding output data that is mapped to the input data.

12. The apparatus of claim 9, wherein the instructions upon execution by the one or more processors, cause the one or more processors to compute the simulated idle time based on a throughput metric associated with the simulated architecture.

13. The apparatus of claim 12, wherein the simulated idle time is a function of the throughput metric and a size of the input data.

14. The apparatus of claim 12, wherein the instructions upon execution by the one or more processors, cause the one or more processors to configure the throughput metric to achieve a performance metric in the simulated architecture.

15. The apparatus of claim 9, wherein the simulator is executed by a first processor, and wherein the simulated architecture is associated with one or more second processors having a higher performance parameter than the first processor.

16. The apparatus of claim 9, wherein the instructions upon execution by the one or more processors, cause the one or more processors to receive a direct memory access (DMA) information from the user application, wherein returning the corresponding output data to the user application is by DMA to the user application.

17. One or more non-transitory computer-readable storage media storing instructions that when executed by one or more processors cause the one or more processors to execute a method for simulating performance of a hardware offloading system, wherein the method comprises:
receiving, by a simulator that corresponds to a simulated architecture representing the hardware offloading system, input data from a user application for processing by the simulated architecture;
preparing, by the simulator, corresponding output data for the input data without computing the corresponding output data by the simulated architecture; and
returning, by the simulator, the corresponding output data to the user application after a simulated idle time related to computing the corresponding output data by the simulated architecture.

18. The one or more non-transitory computer-readable storage media of claim 17, wherein preparing the corresponding output data includes retrieving the corresponding output data from a memory, wherein the corresponding output data is computed during a previous run of the simulator and stored in the memory.

19. The one or more non-transitory computer-readable storage media of claim 18, wherein the corresponding output data is mapped, in the memory, to the input data during the previous run of the simulator, and wherein preparing the corresponding output data includes retrieving the corresponding output data that is mapped to the input data.

20. The one or more non-transitory computer-readable storage media of claim 17, the method further comprising computing the simulated idle time based on a throughput metric associated with the simulated architecture.
